(19) United States
(12) Patent Application Publication
(10) Pub. No.: US 2023/0130643 A1
(43) Pub. Date: Apr. 27, 2023

(54) System and Method for End-to-End Train Trip Management

(71) Applicant: Mitsubishi Electric Research Laboratories, Inc., Cambridge, MA (US)

(72) Inventors: Arvind Raghunathan, Medford, MA (US); Ganesh Janakiraman, Plano, TX (US); Milind Dawande, Plano, TX (US)

(73) Assignee: Mitsubishi Electric Research Laboratories, Inc., Cambridge, MA (US)

(21) Appl. No.: 17/451,540

(22) Filed: Oct. 20, 2021

(51) Int. Cl. G06Q 10/04; G06Q 10/06; G06Q 30/02; G06Q 10/02; G07C 5/00; G06F 17/18; G07C 5/08

(52) U.S. Cl. CPC G06Q 10/04; G06F 17/18; G06Q 10/02; G06Q 10/06315; G06Q 30/0206; G07C 5/008; G07C 5/085

(57) ABSTRACT

A train trip controller system is provided. The train trip controller system may collect operational data for the train, the operational data comprising at least: an itinerary information for a trip the train, constraints on capacity of the train and on ratio between number of passenger cars and number of seats in a particular type of passenger car for different types of passenger cars, an operational cost factor for adding and removing passenger cars, sales horizon condition, and a congestion factor. Based on the operational data, the train trip controller system is configured to determine an upper bound of a stochastic cost function, using a mean of arrival rate of passengers over the sales horizon condition, for each of a different type passenger car. The computation of the upper bound is then used to determine a ticket price and capacity to be used for the train. The determined ticket price and capacity are in turn used to achieve an optimization objective for the train trip controller system.

### TECHNICAL FIELD

The present disclosure relates generally to transportation management, and more specifically to system and method for dynamic configuration of train trips.

### BACKGROUND

A train is a ground transportation management system that serves a set of stations in sequence. The ground transportation management system, such as a train trip management system derives revenue by selling of tickets for different trains for different trips during different times. Hence, it is possible to view the ground transportation management as a revenue management system. However, the revenue of such a system is dependent on similar revenue management systems available in other industries such as airlines, hotels, fashion industry and the like. The revenue management in these similar revenue management systems are mostly based on finite-horizon and fixed resource settings, where horizon refers to a time window provisioned for booking a service, and a resource could be any resource being booked for service. However these similar revenue management systems are not very suitable for train-based ground transportation systems and are not able to fully derive benefits of different structure and operational parameters of the railway industry, which operates train-based ground transportation systems.

The differences in the railway industry are manyfold. For example, in trains, the capacity of a train which is measured in terms of number of passenger cars, can be changed or adjusted for every trip, unlike in a similar industry such as aviation industry, where number of seats in an airplane cannot be changed on a per-trip basis. Another limitation of these known revenue management systems is that calculation of expected revenue is based on a cost function which is not easily tractable due to uncertainty in the demand, and needs complex computational resources for determining revenue, and the performance of these revenue management systems is not guaranteed to be optimal.

Another limitation of the known revenue management systems is that they are based on only two primary factors for revenue calculations using a cost function, which is dependent on consideration of perishable inventory (like in hotel industry) and fixed capacity (such as fixed number of seats in airplanes, or fixed number of rooms in hotels). Thus, these revenue management systems are not able to fully leverage varying capacity considerations in cost function calculations, which could provide further benefits in terms of maximizing profits for a ground transportation system, such as the railway industry.

Accordingly, there is a need for alternative approach for performing train trip management suitable for joint dynamic pricing and sizing in trains.

### SUMMARY

It is an object of some embodiments to provide an end-to-end transportation management system that adaptively connects the passengers’ demand for transportation from origins to destinations with the consideration of capacity configuration of the transportation system servicing this demand. For example, it is an objective of some embodiments to provide an end-to-end ground transportation management service, specifically suited for railway industry and trains. Additionally or alternatively, it is an object of some embodiments to provide an active end-to-end transportation management system that can manipulate the passengers’ demand and the configuration of the transportation system to optimize a performance objective.

For example, it is an object of some embodiments to vary the prices of the transportation service and the size of the means of transportation to optimize a performance objective. Examples of performance objectives include one or a combination of decreasing traffic congestion, increasing throughput of the transportation system, increasing revenue of the transportation system, decreasing cost of the transportation, etc. To that end, it is an objective of some embodiments to vary a ticket price and a capacity in terms of number of passenger cars of a train transportation management system for a train, to optimize the performance objective of maximizing profit for a firm operating the train transportation management.

For example, some embodiments aim to address a train management system that can dynamically determine the price of a ticket and the number of coaches/passenger cars in a train to optimize a performance objective specified by a cost function. This embodiment is advantageous because different passenger cars of the same train may have the same value in the eyes of the passengers but incur different costs for the transportation companies and firms, allowing them to adaptively select the size of each train. On one hand, this scenario is not limited to the train systems but can be extended to other means of transportation such as airplanes and buses with appropriate structural variations, as may be desired. This is because airplanes and buses having the same itinerary and similar schedules as train transportation systems, and also may have the same value in the eyes of the passengers but the different operational costs for the transportation companies. On the other hand, some embodiments are based on a recognition that train transportation significantly varies from other means of transportation making the reuse of their management principles impractical.

For example, some embodiments are based on a recognition that such optimization of performance objectives specified by the cost function can be easily adapted to multiproduct dynamic-pricing problems studied in the revenue management (RM) literature, but vice-versa is not true. Because existing RM methods are not suitable to address some of the above-mentioned objectives, specifically in view of capacity configurations of a transportation unit (like passenger cars in trains).

Some embodiments are based on the recognition that in train transportation management systems, there are fundamentally two different types of products - reserved and unreserved tickets. An unreserved ticket with the flexibility of traveling on multiple trains is unique to the railway industry and is not found in traditional RM settings such as airlines, since an airline ticket is always associated with a specific flight. On the capacity side, there are two different types of capacity in train transportation management systems -reserved and unreserved. The unreserved capacity, measured by the number of unreserved passenger cars, has a feature that in an unreserved passenger car, passengers are allowed to stand, and this is also something that is very unique to the railway industry. Additionally, in the train transportation management systems, capacity can only be added in chunks, i.e., passenger cars. Unlike traditional RM problems, for train transportation, capacity is a decision and there is a cost associated with adding capacity, i.e., passenger cars on each train. The cost function is non-trivial since it has stepwise increments. Also, the reserved capacity to be used on a train is determined as a function of the highest reserved ticket demand. Furthermore, to control congestion on the unreserved passenger cars, a penalty cost for standing needs to be considered.

Specifically, some embodiments are based on a recognition that in the case of a transportation system, the capacity is added in chunks, e.g., by adding passenger cars in trains or by adding additional airplanes and/or buses that can accommodate multiple passengers. Notably, a common practice in the airline industry is that capacity decisions, i.e., flight scheduling decisions are made prior to pricing decisions. Hence, the capacity of a flight is fixed and cannot be changed during the time of sales. In contrast, in the railways industry, there is more flexibility in deciding the capacity of a train and therefore, the pricing and capacity decisions can be made together. The flexibility in changing the capacity of a train arises from the fact that the capacity of a train is made of chunks, i.e., passenger cars. Each additional passenger car on a train results in an increase in operational costs. Since capacity can only be added in passenger cars and not seats, the cost function has stepwise increments.

Some embodiments are further based on the recognition that the railway RM problem is based on consideration of two fundamentally different types products (tickets) sold on a train - reserved and unreserved. Accordingly, there are two types of passenger cars used on a train - reserved and unreserved. A passenger who buys a reserved ticket travels on a reserved passenger car and is guaranteed a seat, whereas a passenger who buys an unreserved ticket travels on an unreserved passenger car and is not guaranteed a seat. Moreover, an unreserved ticket gives the flexibility of traveling on multiple trains operating in a given time window; whilst this flexibility is unavailable for a reserved ticket.

To that end, it is an object of some embodiments to provide a train transportation management system operatively connected to a ticket selling system and a transportation configuration system that can jointly determine a price for the tickets to vary customer demand and the configuration and capacity of the transport servicing this demand by optimizing a cost function of performance objective including stepwise increments of the cost and capacity of adding each passenger car to the transport. On the capacity side of the problem, there exists the flexibility of deciding the number of reserved and unreserved passenger cars to use on each train at the end of the sales horizon.

Some embodiments are further based on the recognition that in some pricing policies the number of passenger cars to use on each train can be decided well in advance at the beginning of the sales horizon. Such a policy is also of interest since it can avoid last-minute decisions on changing the number of passenger cars used on each train. However, a solution to any of the variation of the optimization problem is stochastic in nature, due to the uncertainty of predicting future demand, and is intractable. Further, the modeling of the stepwise cost function makes it even more challenging.

To that end, some embodiments develop an approximation for solving this stochastic optimization with a performance guarantee over an infinite horizon. One embodiment discloses a static pricing policy, whereby the prices are kept fixed for the duration of the sale horizon, and the capacity of the trains is determined at the start of the sales horizon. Another embodiment discloses a static pricing policy where the capacity is determined at the end of the sales horizon. A third embodiment discloses a dynamic pricing policy, whereby the prices of the tickets are varied throughout the sales horizon, and the capacity is determined at the start of the sales horizon. A fourth embodiment discloses a dynamic pricing policy with the capacity of the trains determined at the end of the sales horizon.

Various embodiments provide advancement in computing efficiency for solving a stochastic problem related to management of train trip, by using a train trip controller, that is configured to implement a deterministic solution to determine an upper bound of a stochastic solution to the stochastic problem. Further, the stochastic solution approaches optimality asymptotically. To that end, various embodiments provide for achieving of an optimization objective associated with advancement in computing efficiency, efficient utilization of storage resources and maximizing of profit of an overall train transportation management system using the train trip controller system.

According to some embodiments, a train trip controller system is provided. The train trip controller system is configured to obtain operational data associated with a train. The operational data comprises at least itinerary data of a trip of the train, a first constraint data associated with a number of passenger cars in the train, a second constraint data associated with a ratio between reserved passenger cars with reserved seats and unreserved passenger cars with unreserved seats, a cost of adding and removing a passenger car to the train, a sale horizon condition for selling tickets for the reserved seats and the unreserved seats for itineraries that can be taken on the train, a congestion factor for balancing congestion of standing passengers without seats in the unreserved passenger cars, or a combination thereof. The controller is further configured to determine an asymptotical upper bound of a stochastic cost function of the operational data. The computation of the asymptotical upper bound is based on optimization of a first rate of arrival of the passengers for the reserved seats for each itinerary and a second rate of arrival of the passengers for the unreserved seats for each itinerary. A leg on a train refers to the journey between two consecutive stations on a trip. An itinerary is a journey between a pair of stations served by the trains. To address the statistical nature of the problem, but to make the solution practical, thereby improving the computational efficiency of train trip management system, some embodiments perform the optimization of the first rate of arrival and second rate of arrival by jointly optimizing a deterministic cost function of the operational data over a mean of the first rate of arrival and mean of the second rate of arrival over the sales horizon. The deterministic cost function is used to compute at least a ticket price and a capacity of the train based on the determined stochastical upper bound of the cost function. The computed ticket price and capacity being used to generate a control command to control the trip of the train and submit this control command over a communication channel including one or a combination of a wired channel or a wireless channel, to respective computing systems outputting the ticket price and the capacity for configuration.

Some embodiments provide an end-to-end system for transportation management. The transportation management system comprises a train trip controller system communicatively coupled to a ticket price system and a train configuration system. The ticket price system is configured to output a ticket price and the train configuration system is configured to output numbers of passenger cars of each of a reserved and unreserved type, to configure a capacity of the train. The train trip controller is configured to: obtain operational data associated with the train, the operational data comprising at least: itinerary data of a trip of the train, a first constraint data associated with a number of passenger cars in the train, a second constraint data associated with a ratio between reserved passenger cars with reserved seats and unreserved passenger cars with unreserved seats, a cost of adding and removing a passenger car to the train, a sale horizon condition for selling tickets for the reserved seats and the unreserved seats for each itinerary of the train, a congestion factor for balancing congestion of standing passengers without seats in the unreserved passenger cars, or a combination thereof. The train trip controller is further configured to determine an asymptotical upper bound of a stochastic cost function of the operational data. The asymptotical upper bound being computed based on optimization of a first rate of arrival of the passengers for the reserved seats for each itinerary and a second rate of arrival of the passengers for the unreserved seats for each itinerary. The optimization of the first rate of arrival and the second rate of arrival is performed by jointly optimizing a deterministic cost function of the operational data over a mean of the first rate of arrival over, a mean of the second rate of arrival over the sale horizon. The train trip controller is further configured to compute at least a ticket price and a capacity of the train based on the determined stochastic upper bound of the cost function. Further, the train trip controller is configured to submit a control command to control the trip of the train based on the computed ticket price and the capacity of the train, over a communication channel including one or a combination of a wired channel or a wireless channel. The control command comprises a pricing-based command for the ticket price system, and a capacity configuration command for the train configuration system.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 shows a block of a train transportation management system, according to some embodiments.

FIG. 2A shows a block diagram of various components in the real-world environment of the train transportation management system, according to some embodiments.

FIG. 2B shows a block diagram of different types of pricing policies used in the train transportation management system of FIG. 2A, according to some embodiments.

FIG. 2C shows a block diagram of a cost function used in train trip controller of the train transportation management system of FIG. 2A, according to some embodiments.

FIG. 2D shows a table showing different variables used in computation of the cost function shown in FIG. 2C, according to some embodiments.

FIG. 2E shows a block diagram of a train trip controller used in the train transportation management system of FIG. 2A, according to some embodiments.

FIG. 2F shows a block diagram illustrating the transformation of an intractable problem to a tractable problem for achieving an optimization objective for the train transportation management system, according to some embodiments.

FIGS. 3A-3B show a block diagram of a method for computing a cost function for a train trip controller based on a static pricing policy, according to some embodiments.

FIGS. 4A-4C show a block diagram of a method for computing a cost function for a train trip controller based on a dynamic pricing policy, according to some embodiments.

FIG. 5 shows a working example of the train trip controller system disclosed in various figures, according to some embodiments.

FIG. 6 shows a block diagram of a computing system for implementing a train trip controller, according to some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

The present disclosure provides a system and a method for joint dynamic pricing and sizing for ground transportation management, in accordance with various embodiments. As per various embodiments, a trip controller system is provided, which may be used in the ground transportation management system to effectuate joint dynamic pricing and sizing for the ground transportation management system. In various embodiments, the ground transportation management system comprises an end-to-end train transportation management system, which comprises a train trip controller, configured to implement a deterministic cost function, based on an optimization of a rate of arrival over the sales horizon. The deterministic cost function is used to provide a tractable system for joint dynamic pricing and sizing of trains, in the train transportation management system, with demand rate for bookings averaged over the sales horizon.

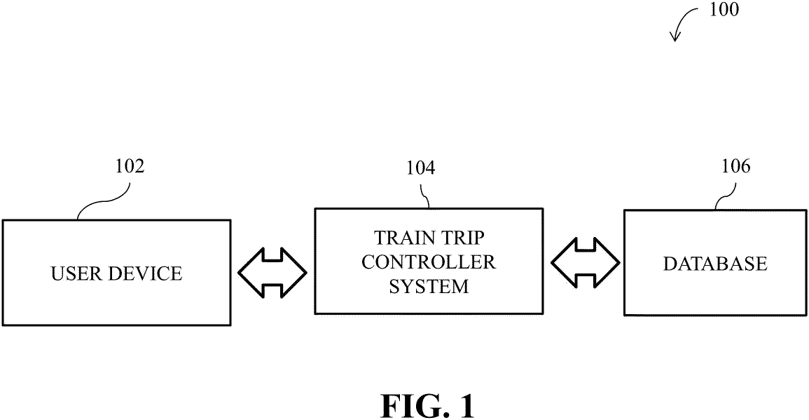

FIG. 1 shows a block of a train transportation management system 100, according to some embodiments. The train transportation management system 100 comprises a user device 102 which sends a booking request to a train trip controller system 104, which may derive data about operational parameters of the train transportation management system 100 from a database 106. The database 106 may store information about various trains, stations, itineraries, origins, destinations, passenger car information, number of seats in each passenger car and the like.

A user, such as a passenger may send a request for booking a ticket for a trip by a train, serving an origin location and a destination location of the trip by having stations at the origin location and the destination location accordingly. The train may consist of two types of passenger cars: a reserved passenger car and an unreserved passenger car. The reserved passenger car is booked by a reserved ticket, and the unreserved passenger car is booked by an unreserved ticket. Each ticket specifies an itinerary, a date, and a train on which the passenger wishes to travel. Further, the passenger cannot travel with this ticket on any train other than the one specified in her ticket. For a reserved ticket, the passenger is guaranteed a seat, during her trip, on the train specified by her ticket. An unreserved ticket, on the other hand, specifies only the itinerary and date of travel, and does not specify the train on which the passenger needs to travel. The passenger may travel with this ticket on any train operated during the date of travel of her ticket. However, she is not guaranteed a seat on any of the trains. In some implementations, the price of the reserved ticket is different from the price of the unreserved ticket. Also, the number of passenger cars used on a train is referred to herein as the capacity of the train. The number of reserved passenger cars is referred to herein as the reserved capacity, while the number of unreserved passenger cars is referred to herein as the unreserved capacity respectively for the train. To that end, the train trip controller system 104 may be configured to submit a control command for providing a non-anticipatory pricing policy for train tickets and also to determine the number of reserved and unreserved passenger cars on each train.

In some embodiments, the train trip controller system 104 includes a memory to store instructions, at least one processor to execute the instructions for controlling the trip of the train by generating control commands for ticket pricing and train configuration control respectively. The train trip controller system 104 may be in communication with all other components associated with the train transportation system via a communication channel, which may be a combination of a wired channel or a wireless channel. To that end, the train transportation management system may be a specific embodiment of any end-to-end ground transportation management system in which price and capacity of an associated product or means of transport can be changed based on a demand function associated with the product or the means of transport.

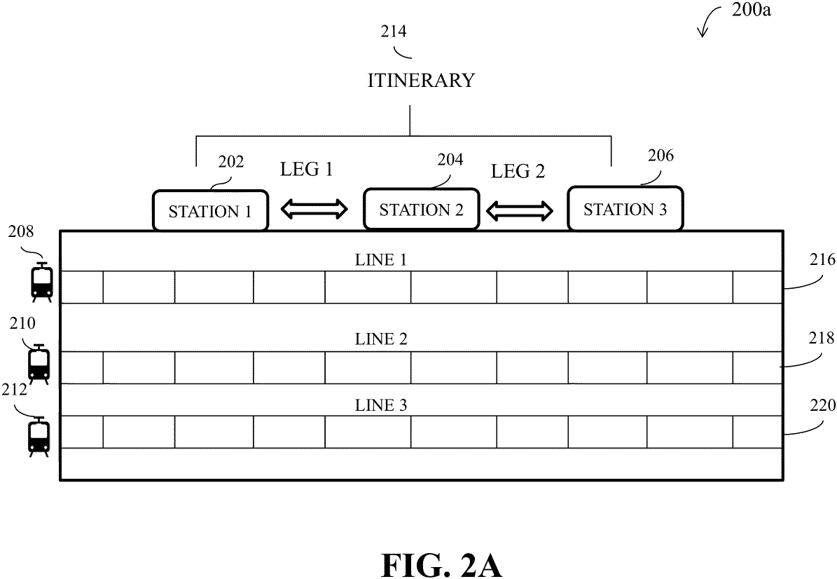

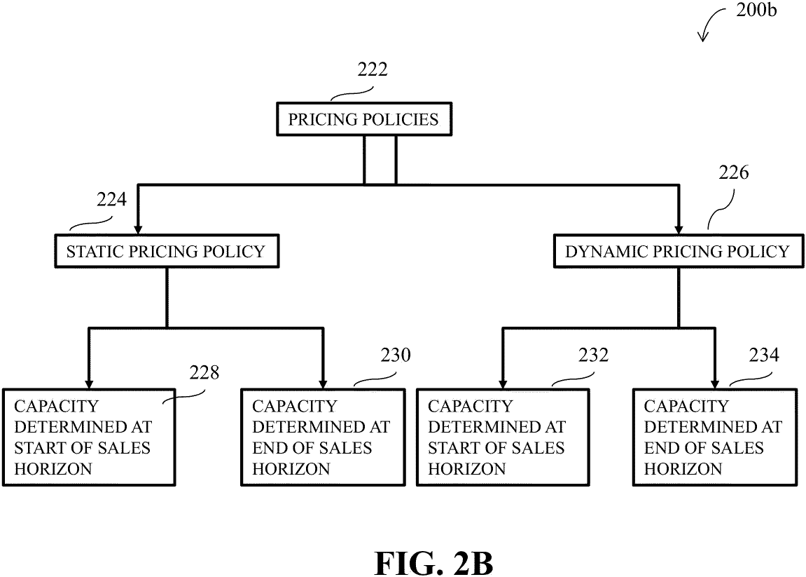

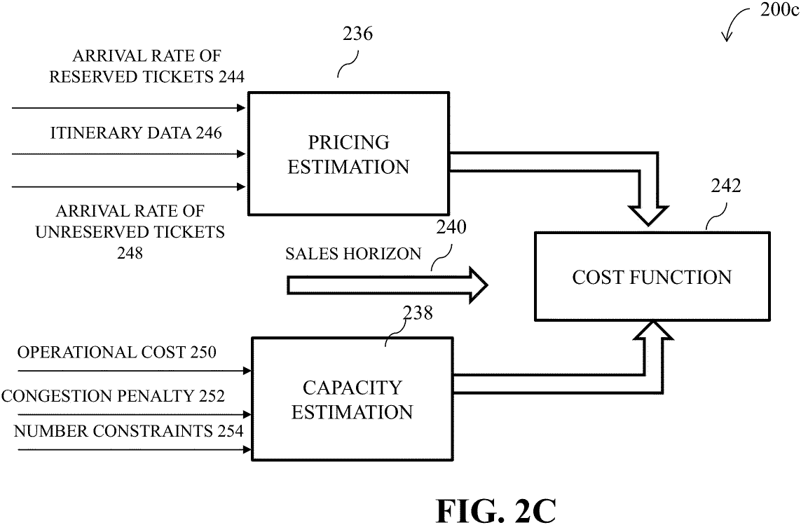

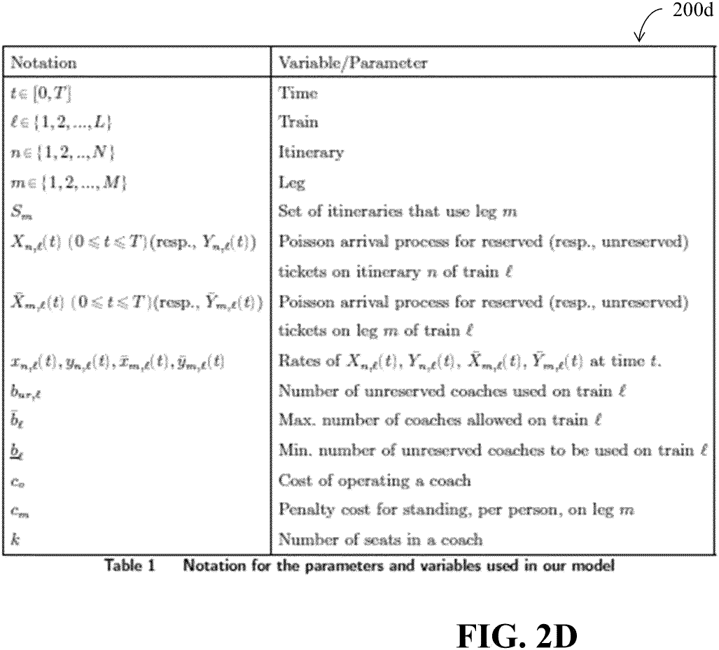

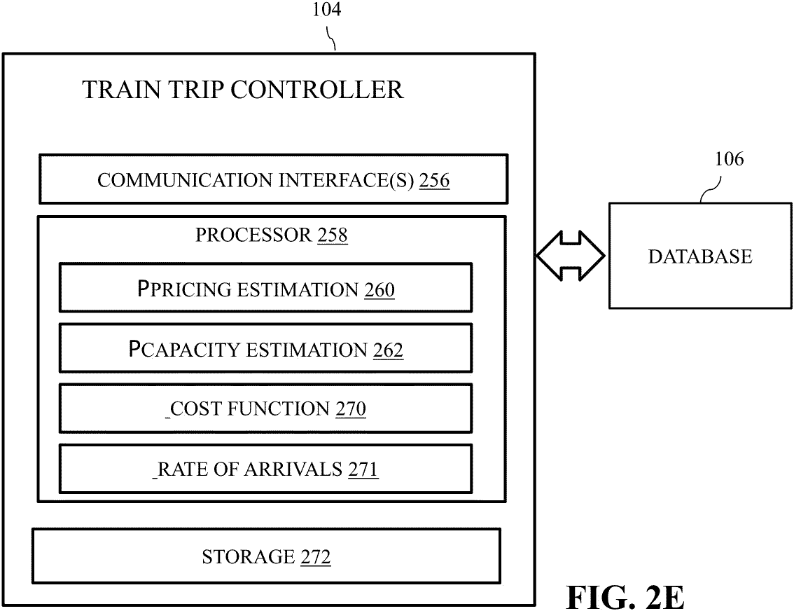

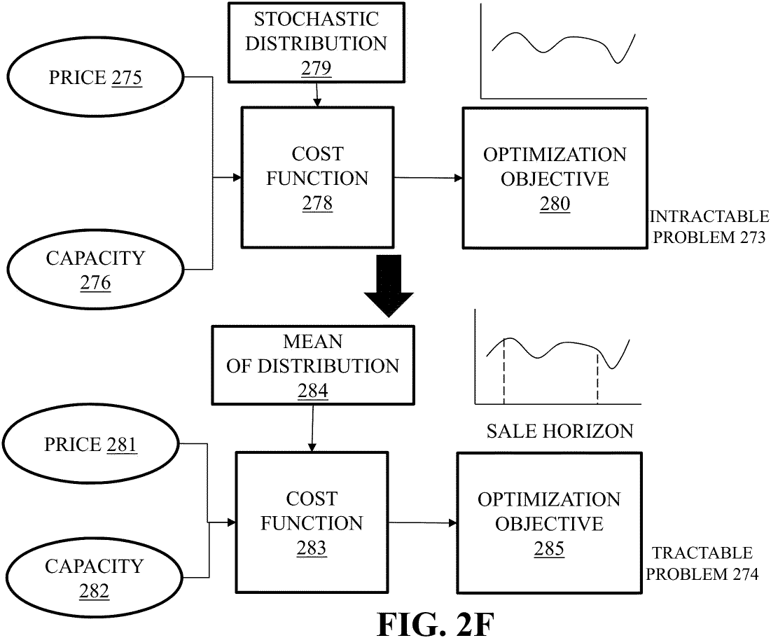

FIG. 2A shows a block diagram 200a of various components in the real-world environment of the train transportation management system 104 shown in FIG. 1, according to some embodiments. The train transportation management system may serve a plurality of stations 202-206 by one or more trains 208-212, running on one or more corresponding lines or pathways 216-220. A line from the one or more lines 216-220, refers to a set of stations that are served by the train starting from an origin station and ending at terminal station. A train refers to a physical transportation service that runs on the line, starting at the origin station at a particular time. For example, there is a train that starts at 10am and another train that starts at 11 am and so on. For any trip of a train from the one or more trains 208-212, a leg on a train refers to the journey between two consecutive stations. For example, for the train 208, the journey between station 202 and station 204 is leg 1 for the train 208. Similarly, the journey between the station 204 and the station 206 is leg 2 for the train 208.

Further, an itinerary refers to a pair of stations from one of which a passenger can board the train and reach the other station for a journey between a pair of stations served by the trains. For example, for the train 208, an itinerary 214 may refer to journey or trip of the train 208 between the stations 202-206 on the line 216. Similarly, the itinerary for the train 210 may refer to the trip of the train 210 between the stations 202-206 on the line 218. Further, any combination of stations may form an itinerary for any of the trains. The information about the trains (such as trains 208-212), the lines (such as the lines 216-220), the stations (such as the stations 202-206), and the itineraries data (such as itinerary 214), may be stored in the database 106 shown in FIG. 1. The train trip controller system 104 may be configured to obtain any such information from the database 106 as an operational data associated with a train, at any time as specified by a sales horizon for managing a trip of the train.

To that end, each train may be associated at least two types of tickets on any itinerary: a reserved ticket and an unreserved ticket (as also mentioned briefly earlier in conjunction with FIG. 1). The reserved ticket specifies the itinerary, date, and train on which a user, such as a passenger on any of the trains 208-212, needs to travel. Corresponding to the two type of tickets, the train trip controller system 104 is also configured to control configuration data for operating the two types of passenger cars on each train -the reserved passenger car and the unreserved passenger car. The passengers who buy a reserved (and respectively an unreserved) ticket can travel only on a reserved (and respectively an unreserved) passenger car. To that end, both the types of tickets may be sold in advance for all the itineraries and the train trip controller system 104 may be configured to vary the prices of any itinerary till the journey commences.

Various embodiments provide that the price of a reserved ticket of an itinerary on any train, may affect the demand of both reserved and unreserved tickets on itinerary on all the trains. Further, the price of an unreserved ticket on the itinerary may affect the demand of both reserved and unreserved tickets on itinerary on all the trains. In addition to varying prices over time, the train trip controller 104 may be configured to decide the capacity of each train, i.e., the number of reserved and unreserved passenger cars to use for each train.

Some embodiments provide that all the passenger cars are identical. Alternatively, some embodiments provide that at least some of the passenger cars are different. Therefore, to manage congestion in the unreserved passenger cars, there may be further operational data that may be obtained by the train trip controller system. This may include such as a first constraint data associated with a number of passenger cars in the train, a second constraint data associated with a ratio between reserved passenger cars with reserved seats and unreserved passenger cars with unreserved seats, a cost of adding and removing a passenger car to the train, and a congestion factor for balancing congestion of standing passengers without seats in the unreserved passenger cars.

To that end, the train trip controller system 104 may be configured to determine a penalty function for managing congestion for the number of passengers standing on a particular leg of the train. This penalty function may be varied to target different congestion levels. Further each of the constraints mentioned above may be considered due to constraints such as limited length of platforms on stations, as a result of which an upper bound on the number of passenger cars used on the trains may be determined. Furthermore, some constraints may be applied to provide a flexibility for passengers and railway firms, such as the unreserved capacity of each train should be at least a certain number. Therefore, an additional constraint which requires a railway firm operating the train trip controller system 104 to use at least a minimum number of unreserved coaches on train may also be imposed.

To that end, the train trip controller system may be configured to provide different types of pricing policies based on the various constrains described above.

FIG. 2B shows a block diagram 200b of different types of pricing policies 222 used in the train transportation management system implementing the train trip controller system 104 of FIG. 2A, according to some embodiments.

The pricing policies 222 may be majorly of two types - a static pricing policy 224, and a dynamic pricing policy 226. For the static pricing policy 224, the prices of any tickets, be it for reserved or unreserved seats, remain fixed during a sales horizon. On the other hand, for the dynamic pricing policy 226, the prices of the tickets, be it for reserved or unreserved seats, may be changed during a sales horizon. The change may be triggered in some embodiments by a demand rate of arrival of passengers.

For any type of policy, there can be an associated capacity determination decision, which may either be taken at a start of sales horizon or an end of sales horizon. Sales horizon refers to the period over which the tickets for any train are sold. For example, for all the trains operating on August 15th , tickets may be sold from July 15th till August 14th. Accordingly, the train trip controller system 104 may vary the price of any itinerary (on August 15th) during this time based on the type of the pricing policy.

To that end, for the static pricing policy 224 may have two types -a static pricing policy with capacity determined at the start of sales horizon 228, and a static pricing policy with capacity determined at the end of sales horizon 230.

Similarly, for the dynamic pricing policy 226 also, there may be two types - a dynamic pricing policy with capacity determined at the start of sales horizon 232, and a dynamic pricing policy with capacity determined at the end of sales horizon 234.

Each of these types of policies may contribute as operational data that is used for determining an asymptotical upper bound of a stochastic cost function of the operational data, using joint pricing and capacity configuration decisions.

In some embodiments, the static pricing policy 224 is preferred, due to its relative ease of implementation and attractive performance guarantee, as compared to the dynamic pricing policy 226. Further, the static pricing policy 224 is also asymptotically optimal when the demand and capacity are proportionally scaled, thereby being related to a tractable problem. The demand for tickets of any type may be determined on the basis of a demand function that refers to the function that determines the demand for an itinerary on a specific train. This rate demands on the price for the itinerary on all the trains. Suppose there are two trains one that starts at 10 am and another that starts at 11 am. For example, arrival rate for a particular itinerary can depend on the prices for the itinerary on both the trains. This models the possibility that passengers may change their travel schedule based on when the prices are cheaper.

To that end, an arrival rate for an itinerary refers to the rate at which demand for a particular itinerary on a specific train arrives. This is equal to the value of the demand function once the prices for an itinerary on different trains are specified. For example, for reserved passenger cars, for reserved seats on a leg, there may be a first arrival rate that is based on demand for the reserved seats received during the sales horizon for that leg of a trip. Similarly, for unreserved passenger cars, for unreserved seats on a leg, there may be a second arrival rate that is based on demand for the unreserved seats received during the sales horizon for that leg of the trip. Each of these may further contribute as operational data of a train.

Some embodiments are based on the recognition that passenger arrivals and correspondingly first and second arrival rates are Poisson distributions, with arrival rates that depend stochastically on the prices of the tickets. The number of reserved and unreserved passenger cars to be used on any train may be decided at the end of the sales horizon. For every passenger car used on a train, there is an associated operational cost. Also, there are constraints on the total number of passenger cars and the number of unreserved passenger cars used on each train. Furthermore, every passenger on a reserved passenger car needs a guaranteed seat for every reserved ticket sold on all the itineraries, on all the trains.

Based on all the above-mentioned constraints, operational data and pricing and capacity dynamics, a combined cost function based on optimized arrival rate is determined, that maximizes the profit generated by the train trip controller system 104.

FIG. 2C shows a block diagram 200c of a cost function 242 used in the train trip controller 104 of the train transportation management system of FIG. 2A, according to some embodiments. The cost function is determined based on a joint estimation of pricing 236 and capacity 238 of the train transportation system, as computed over a sales horizon 240 based on a condition specifying whether to calculate cost and capacity at the start of the sales horizon 240 or at the end of the sales horizon 240. The cost function 242 is a stochastic cost function of operational data. The operational data comprises pricing estimation data, capacity estimation data and sales horizon 240 data.

The pricing estimation related operational data comprises itinerary data 246 of a trip of a train, arrival rate of reserved tickets 244, and arrival rate of unreserved tickets.

Further, the capacity estimation related data comprises an operational cost 250 for adding and/or removing a passenger car to the train, a congestion penalty factor 252 for balancing congestion of standing passengers without seats in the unreserved passenger cars for a leg of the train, and various number constraints 254. The number constraints include, for example, a first constraint data associated with a number of passenger cars in the train (that is the total number), and second constraint data associated with a ratio between reserved passenger cars with reserved seats and unreserved passenger cars with unreserved seats.

The operational data inputs may be obtained by the train trip controller system 104, such as from data stored in the database 106. This operational data, which is a combination of the pricing estimation 236 data and the capacity estimation data 238, is then used by the train trip controller system 104 to determine an asymptotical upper bound of a stochastic cost function of the operational data, the asymptotical upper bound being computed based on optimization of the first rate of arrival of the passengers for the reserved seats for each itinerary and the second rate of arrival of the passengers for the unreserved seats for each itinerary. The optimization of the first rate of arrival and second rate of arrival is performed jointly, i.e., interdependently on each other, by optimizing the deterministic cost function 242 of the operational data over a mean of the second rate of arrival over the sale horizon 240.

Further, based on the stochastic upper bound of the cost function 242, as determined based on operational data, a ticket price, and a capacity for the train is determined, for each of the reserved and the unreserved passenger cars. This computed ticket price and capacity is then submitted back to the train trip controller system 104, in the form of a control command. The control command then effectuates a ticket pricing system and capacity configuration system to output the ticket price and the capacity of the train respectively.

This computation of cost function, ticket price, capacity configuration and optimized arrival rate values may be explained in conjunction with an example described below.

For example, a railway firm may comprise a data center which further comprises a server computer that embodies the train trip controller system 104. The railway firm operates multiple trains at different times on a single railway line serving multiple stations. Consider there are L trains serving M +1 stations which include the start and the end stations. Therefore, the travel comprises of M legs and

$$\text{N =} \left(\begin{matrix}M + 1 \\ 2\end{matrix}\right)$$

possible itineraries on a train 1, where 1≤ l ≤ L. As is known from the description above, there are two types of tickets on any itinerary - reserved ticket and unreserved ticket. The price of a reserved ticket on an itinerary n, 1 ≤ n ≤ N, on any train may affect the demand of both reserved and unreserved tickets on itinerary n on all the trains. Similarly, the price of an unreserved ticket on an itinerary n, 1 ≤ n ≤ N, on any train may affect the demand of both reserved and unreserved tickets on itinerary n on all the trains. Further, price of any ticket on itinerary n on any train may not affect the demand of tickets on any other itinerary on all the trains.

Further, let T be a duration of the sales horizon 240. Let p_{n,1}(t) be a price of a reserved ticket on itinerary n on train l at time t (0≤ t ≤ T and qₙ(t) be a price of an unreserved ticket on itinerary n at time t. Further, a Poisson first rate of arrival of the passengers for the reserved seats for each leg of the itinerary n may be (X_{n,1}(t)) and a Poisson second rate of arrival of the passengers for the unreserved seats for each leg of the trip may be (Y_{n,1}(t)). The demand rate vector for a reserved ticket on itinerary n for all the trains is x̅ₙ= (X_{n,1}, ..., X_{n,1}), and the demand rate of an unreserved ticket on itinerary n, yₙ, depends on the price vector of a reserved ticket on itinerary on all the trains, p̅=(p_{n,1}, ..., p_{n,L}), and also the price of an unreserved ticket on itinerary n, qₙ. The demand function for itinerary n on all the trains is denoted by λₙ(̅p̅ₙ, qₙ): R^{L+1} -> R^{L+1}; that is, (x̅ₙ, yₙ) = λₙ(̅p̅ₙ, qₙ). Also, the inverse function of the function λₙ(.) is denoted by ζₙ(.). That is to say λₙ(ζₙ(x̅ₙ, yₙ)) = (x̅ₙ, yₙ). Thus, the revenue rate of the firm, from itinerary n, as a function of the demand rate is given as rₙ(x̅ₙ, yₙ) = (x̅ₙ, yn). ζₙ(x̅ₙ, yn).

Additionally, Sₘ may represent the set of all itineraries that use a leg m, 1≤m≤M. The Poisson rate of arrival of reserved tickets of each leg m on train I is given by X̅_{m,1} (t) = Σ_{n∈Sm} X_{n,l}(t) and the Poisson and the first rate of arrival of the passengers on the reserved seats at time t may thus be written as x_{m,1}(t) = Σ_{n∈Sm} x_{n,l}(t).

Similarly, the arrivals for an unreserved ticket (and corresponding second rate of arrival for of the passengers for the unreserved seats) which uses leg on train 1 are also Poisson and are given by Y_{m,l} (t) = Σ_{n∈Sm} Y_{n,l}(t). Similarly, the second rate of arrival of the passengers on the reserved seats at time t may thus be written as y_{m,l}(t) = Σ_{n∈Sm} y_{n,l}(t).

Some embodiments are based on the recognition that all the passenger cars are identical and let k be the number of seats in each coach. Let 4cₒ be the operational cost of operating a passenger car and b_{ur,1} may be the number of unreserved passenger cars used on train l, b̅ᵤᵣ= (b_{ur,1}, ... , b_{ur,L}).

Additionally, the congestion factor associated with penalty for every standing passenger in the unreserved passenger cars is cₘ on any leg m. This congestion factor may be varied to target varied congestion levels. Apart from this, the numerical constraints on the capacity of each train may be represented by imposing an upper bound on the number of passenger cars that may be used on the train. This upper bound on maximum may be denoted as b̅₁ number of passenger cars. Similarly an additional constraint on minimum number of unreserved passenger cars is b₁.

These different operational parameters may be represented as depicted in Table 1 shown in FIG. 2D for example.

Based on all the operational data discussed above the train trip controller system 104 may be used to determine an optimized deterministic cost function of the operational data over a mean of the first rate of arrival over the sale horizon and optimized deterministic cost function of the operational data over a mean of the second rate of arrival over the sale horizon. To that end, the train trip controller system 104 is configured to compute at least a ticket price and a capacity of a train based on the determined stochastic upper bound of the cost function using at least a processor configured to store instructions stored in a memory.

FIG. 2E shows a block diagram of a train trip controller used in the train transportation management system of FIG. 2A, according to some embodiments. The train trip controller system 104 comprises one or more communication interfaces 256 for submitting a control command over a communication channel, for controlling at least the ticket price and capacity configuration of the train.

The train trip controller system 104 further comprises at least a processor 258 configured to implement modules such as a pricing estimation module 260, a-capacity estimation module 262, a cost function module 270, and a rate of arrivals module 271 for executing computer-executable instructions.

The train trip controller system 104 also comprises at least one non-transitory computer readable storage medium, such as the storage 272, for storing the computer-executable instructions for carrying out functionalities of the various modules of the train trip controller 104.

The train trip controller system 104 may also be configured to communicate with the database 106 over a wired or wireless communication channel. The database 106 is configured for storing all the operational data, parameters, capacity configuration details for the train, itinerary details, ticket prices and the like.

The train trip controller system 104 is also configured to determine a deterministic problem for cost function calculation by cost function 270 module based on the first and the second rates of arrivals 271. In order to improve the overall computational efficiency and to make the problem of pricing and capacity determination practically tractable, some embodiments replace the stochastic representation of the arrivals 271, such as Poisson arrival rates X̅_{m,l} (t) and Y̅_{m,l} (t) with deterministic arrivals as a mean of the first rate of arrival and a mean second rate of arrival over the sale horizon. This has the advantage that a deterministic problem is a convex function and can hence be solved efficiently, by using the static policy 224 for finding optimal solution to the deterministic problem. The deterministic problem based on all operational data as discussed above may be given as:

[symbol]

The conversion of an intractable stochastic problem to a tractable deterministic problem listed above is done to achieve an optimization objective. The optimization objective may include higher computing efficiency, better storage capabilities, maximizing revenue, improving response time of the train trip controller system 104, and the like. The conversion of intractable problem to a deterministic tractable problem is depicted in FIG. 2F.

FIG. 2F illustrates that an intractable problem 273 of determination of a cost function 278 associated with an optimization objective 280, is transformed to a tractable problem 274 of determination of a deterministic cost function 283 associated with an optimization objective 285. This is achieved by having the cost function 283 determined based on a price related operational data 281, a capacity related operational data 282, and a mean distribution of the first arrival rate and the second arrival rate over the sale horizon.

To that end, the cost function 278 is determined based on a capacity data 276, a price data 275 and a stochastic distribution 279 of the first arrival rate and the second arrival rate. The stochastic distribution 279 makes the overall cost function 278 determination to achieve the optimization objective 280, an intractable problem. On the other hand, the mean of distribution 284 takes mean of the first arrival rate and the second arrival rate respectively during the sale horizon. As a result, the optimization objective 285 associated with efficiency and maximizing profit for the train transportation management system or the train trip controller system 104, may be easily achieved.

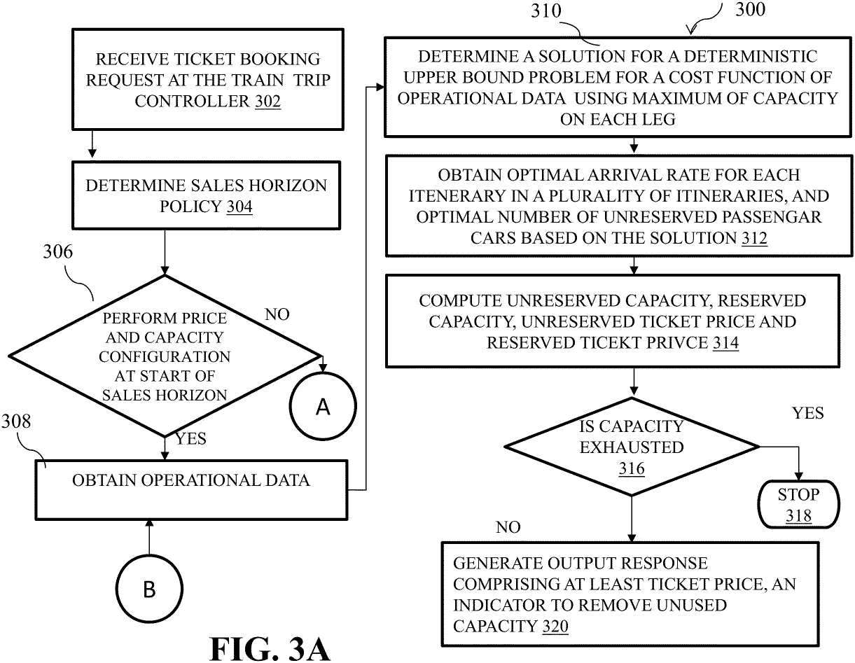

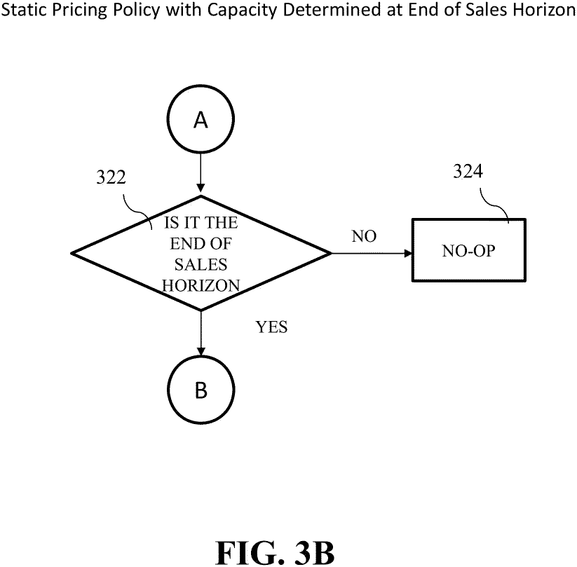

FIGS. 3A-3B show a block diagram of a method 300 for computing an optimal solution to the cost function 242 of FIG. 2C, by the train trip controller system 104 based on a static pricing policy, such as the static pricing policy 224 shown in FIG. 2B, according to some embodiments.

The method 300 may be implemented by various modules of the train trip controller system 104, by storing computer-executable instructions in storage 272 (shown in FIG. 2E), and the computer-executable instructions being executed by the processor 258 (shown in FIG. 2E) by invoking functionalities of various modules as required. The computer-executable instructions associated with different modules may be sub-routines or algorithms which are executed in specified sequence, to achieve the overall functionalities of the train trip controller system 104. FIGS. 3A - 3B are explained in conjunction with FIG. 1, FIG. 2A, FIG. 2B, FIG. 2C, FIG. 2D and FIG. 2E

At step 302, a ticket booking request is received at the train trip controller system 104. The ticket booking request may be received from a passenger wishing to travel on a train l, for a particular itinerary n, for any of a reserved or an unreserved passenger car of the train. Based on receiving of the request at a particular time, computations for ticket price and capacity of the train are performed based on a number of operational data that may be retrieved from the database 106.

However, the computations are performed only after, at step 304, determining a sales horizon policy. The sales horizon policy may indicate either of performing computations of price and capacity configuration at the start of the sales horizon or performing computations of price and capacity configuration at the end of the sales horizon. The sales horizon policy data may also be stored in the database 106. After retrieving this data, at step 306, it may be determined if the sales horizon policy data indicates selling of tickets at the start of the sales horizon, then at step 308, operational data associated with the train l, may be obtained. But if the sales horizon policy data does not indicate selling of tickets at the start of the sales horizon, then at step 322 shown in FIG. 3B, it is checked if it is end of sales horizon. To that end, the train trip controller system 104 waits till the end of the sales horizon is reached. If yes, then method 300 returns to step 308 shown in FIG. 3A, otherwise at step 324 shown in FIG. 3B, no operation is performed.

The operational data may comprise at least: itinerary data n of a trip of the train, a first constraint data associated with a number of passenger cars in the train b̅, a second constraint data associated with a ratio between reserved passenger cars with reserved seats and unreserved passenger cars with unreserved seats, a cost of adding and removing a passenger car to the train (such as cₒ), a sale horizon condition and duration T for selling tickets for the reserved seats and the unreserved seats for each leg m of the trip, a congestion factor cₘ for balancing congestion of standing passengers without seats in the unreserved passenger cars, or a combination thereof.

Based on this operational data, at step 310, a solution for a deterministic problem may be computed for determining an asymptotical upper bound of a stochastic cost function of the operational data may be computed using maximum capacity on each leg m of the train l. The deterministic problem may be given as:

[symbol]

Then, at step 312, an optimal first rate of arrival (X_{n,1}(t)) of the passengers for the reserved seats for each leg of the trip and an optimal second rate of arrival (Y_{n,1}(t)) of the passengers for the unreserved seats for each leg of the trip for each itinerary n in a plurality of itineraries N. The optimal first rate of arrival may be computed by optimizing the deterministic cost function of the operational data over a mean of the first rate of arrival (X_{n,1}(t)) over the sale horizon T. Similarly, the optimal second rate of arrival may be computed by optimizing the deterministic cost function of the operational data over a mean of the second rate of arrival (Y_{n,1}(t)) over the sale horizon T.

Then, at step 314, a ticket price and a capacity of the train may be computed for each of the reserved passenger cars, the unreserved passenger cars, the reserved capacity, and the unreserved capacity. For example, the unreserved capacity may be determined as

$$\left⌊{b}_{u r , l}^{*}\right⌋ ,$$

the reserved capacity may be determined as

$$\frac{\text{max} \left(\overline{x {*}_{m , l} :} 1 \leq m \leq M\right) T}{k}$$

, the ticket price of the reserved tickets may be determined to follow a price path

$${p}_{n , l}^{h} \left(t\right)$$

till the number of legs sold on train equals

$$\left⌈\frac{\text{max} \left(\overline{x {*}_{m , l} :} 1 \leq m \leq M\right) T}{k}\right⌉$$

(reserved capacity of train) or the end of sales horizon is reached. The ticket price of the unreserved tickets may be determined to follow the price path of

$${q}_{n , l}^{h} \left(t\right)$$

till the number of seats sold on one of the legs of the train equals optimal arrival rate of unreserved passenger cars

$${\overline{y}}_{m , l}^{*} \text{T} .$$

Then, at step 316, it is checked if the capacity on any leg of the train is exhausted. To that end, the computed capacity for the train l is compared with a capacity exhaustion threshold. To that end, if the computed capacity of the train is more than the capacity exhaustion threshold, then at step 318, no further computations are performed, and appropriately capacity exhaustion notification is generated.

If the computed capacity of the train is lesser than or equal to the capacity exhaustion threshold, then, at step 320, these computed ticket price and capacity are then outputted for submission, as a control command to control the trip of the train.

Thus, using the method 300, the train trip controller system 104 is able to provide a static pricing policy-based ticket price and capacity computation for a train, based on an optimal solution to the deterministic cost function calculation problem of the operational data over a mean of rate of arrival of passengers over the sales horizon. The method 300 is based on static pricing policy as the price of any of reserved or unreserved tickets corresponding to reserved or unreserved seats respectively does not change during the sales horizon specified by the sales horizon condition.

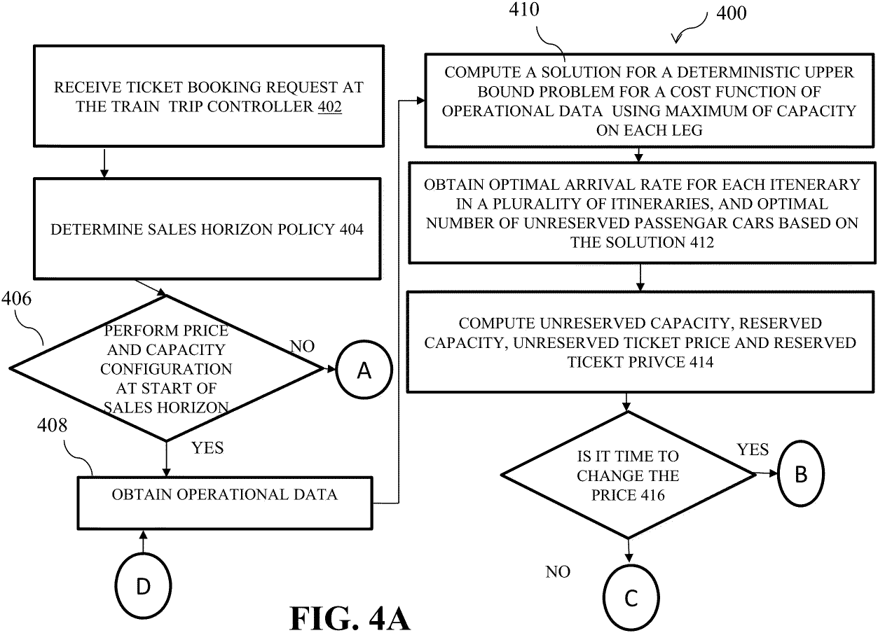

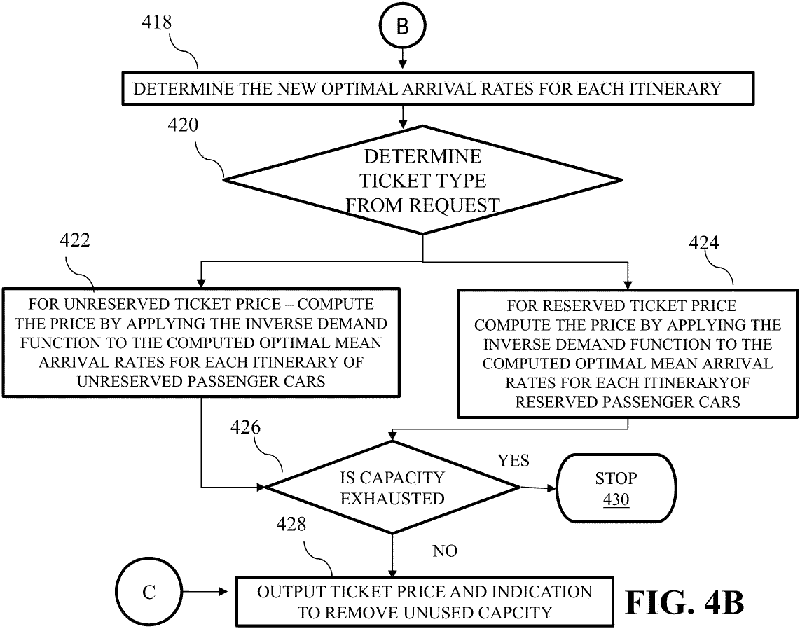

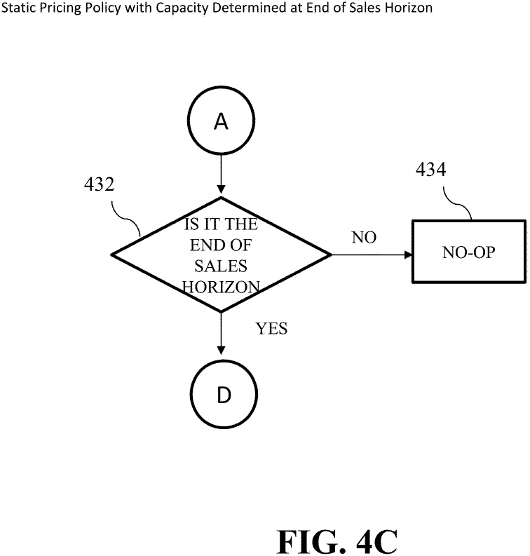

A similar method is illustrated in FIGS. 4A-4C, with the difference that the method shown in FIGS. 4A-4C is based on a dynamic pricing policy.

FIGS. 4A-4C show a flowchart of a method 400 for computing a cost function for the train trip controller system 104 based on a dynamic pricing policy, according to some embodiments. Most of the steps of the method 400 are similar to the respective steps of the method 300 shown in FIGS. 3A-3B, but there are also differences in other steps based on the dynamic pricing policy, such as the dynamic pricing policy 226 shown in FIG. 2B, according to some embodiments.

The method 400 may be implemented by various modules of the train trip controller system 104, by storing computer-executable instructions in storage 272 (shown in FIG. 2E), and the computer-executable instructions being executed by the processor 258 (shown in FIG. 2E) by invoking functionalities of various modules as required. The computer-executable instructions associated with different modules may be sub-routines or algorithms which are executed in specified sequence, to achieve the overall functionalities of the train trip controller system 104. FIGS. 3A - 3B are explained in conjunction with FIG. 1, FIG. 2A, FIG. 2B, FIG. 2C, FIG. 2D and FIG. 2E

At step 402, a ticket booking request is received at the train trip controller system 104. The ticket booking request may be received from a passenger wishing to travel on a train l, for a particular itinerary n, for any of a reserved or an unreserved passenger car of the train. Based on receiving of the request at a particular time, computations for ticket price and capacity of the train are performed based on a number of operational data that may be retrieved from the database 106.

However, the computations are performed only after, at step 404, determining a sales horizon policy. The sales horizon policy may indicate either of performing computations of price and capacity configuration at the start of the sales horizon or performing computations of price and capacity configuration at the end of the sales horizon. The sales horizon policy data may also be stored in the database 106. After retrieving this data, at step 406, it may be determined if the sales horizon policy data indicates selling of tickets at the start of the sales horizon, then at step 408, operational data associated with the train l, may be obtained. But if the sales horizon policy data does not indicate selling of tickets at the start of the sales horizon, then at step 432 shown in FIG. 4C, it is checked if it is end of sales horizon. To that end, the train trip controller system 104 waits till the end of the sales horizon is reached. If yes, then method 400 returns to step 408 in FIG. 4A, otherwise at step 434 shown in FIG. 4C, no operation is performed.

The operational data may comprise at least: itinerary data n of a trip of the train l, a first constrain data associated with a number of passenger cars in the train b̅, a second constrain data associated with a ratio between reserved passenger cars with reserved seats and unreserved passenger cars with unreserved seats, a cost of adding and removing a passenger car to the train (such as cₒ), a sale horizon condition and duration T for selling tickets for the reserved seats and the unreserved seats for each leg m of the trip, a congestion factor cₘ for balancing congestion of standing passengers without seats in the unreserved passenger cars, or a combination thereof.

Based on this operational data, at step 410, a solution for a deterministic problem may be computed for determining an asymptotical upper bound of a stochastic cost function of the operational data. The stochastic upper bound may be computed using maximum capacity on each leg m of the train l. The deterministic problem may be given as:

[symbol]

Then, at step 412, an optimal first arrival rate (X_{n,1}(t)) of the passengers for the reserved seats for each leg of the trip and an optimal second rate of arrival (Y_{n,1}(t)). of the passengers for the unreserved seats for each leg of the trip for each itinerary n in a plurality of itineraries N. The optimal first rate of arrival may be computed by optimizing the deterministic cost function of the operational data over a mean of the first rate of arrival (X_{n,1}(t)) over the sale horizon T. Similarly, the optimal second rate of arrival may be computed by optimizing the deterministic cost function of the operational data over a mean of the second rate of arrival (Y_{n,1}(t)) over the sale horizon T.

Then, at step 414, a ticket price and a capacity of the train may be computed for each of the reserved passenger cars, the unreserved passenger cars, the reserved capacity, and the unreserved capacity. For example, the unreserved capacity may be determined as

$$\left⌊{b}_{u r , l}^{*}\right⌋ ,$$

the reserved capacity may be determined as

$$\left⌈\frac{\text{max} \left(\overline{x {*}_{m , l} :} 1 \leq m \leq M\right) T}{k}\right⌉$$

, the ticket price of the reserved tickets may be determined to follow a price path

$${p}_{n , l}^{h} \left(t\right)$$

(t) till the number of legs sold on train equals

$$\left⌈\frac{\text{max} \left(\overline{x {*}_{m , l} :} 1 \leq m \leq M\right) T}{k}\right⌉$$

(reserved capacity of train) or the end of sales horizon is reached, and the ticket price of the unreserved tickets may be determined to follow the price path of

$${q}_{n , l}^{h} \left(t\right)$$

till the number of seats sold on one of the legs of the train equals optimal arrival rate of unreserved passenger cars

$${\overline{y}}_{m , l}^{*} \text{T} \text{.}$$

Then, at step 416, a dynamic price factor associated with updating the ticket price after a predetermined time interval. For example, it may be checked if the predetermined time interval, say of 120 minutes, has elapsed. The dynamic price factor may be a flag with values, such as 0 and 1, for indicating whether the predetermined time interval has elapsed or not. For example, in some embodiments, the value of 1 may indicate that the predetermined time interval has elapsed, while the value of 0 may indicate that the predetermined time interval has not elapsed. In some embodiments, vice-versa may be true.

To that end, if the dynamic price factor indicates that the predetermined time interval has elapsed, then at step 418 shown in FIG. 4B, new optimal arrival rates for each itinerary n may be determined. Accordingly, at step 420, a ticket type may be checked, such as an unreserved ticket or a reserved ticket. Based on the determination the ticket prices may be updated. For example, at step 422, the unreserved ticket price may be updated, such as by applying the inverse demand function to the computed mean second rate of arrival for each itinerary of the unreserved passenger cars.

Further, at step 424, the reserved ticket price may be updated, such as by applying the inverse demand function to the computed mean first rate of arrival for each itinerary of the reserved passenger cars.

Then, at step 426, it is checked if the capacity on any leg of the train is exhausted. To that end, the computed capacity for the train l is compared with a capacity exhaustion threshold. To that end, if the computed capacity of the train more than the capacity exhaustion threshold, then at step 430, no further computations are performed, and appropriately capacity exhaustion notification is generated.

If the computed capacity of the train is lesser than or equal to the capacity exhaustion threshold, then, at step 428, these computed ticket price and capacity are then outputted for submission, as a control command to control the trip of the train.

Referring back to step 416, if it is determined that it not yet time to change the ticket prices, then control passed directly to step 428. Thus, the methods 300 and 400 shown in FIGS. 3A-3B and FIGS. 4A-4C respectively may be executed by the train trip controller system 104 to manage end-to-end transportation for a train-based system, by joint pricing and capacity configuration-based determination of the deterministic cost function problem, in order to provide maximum profit.

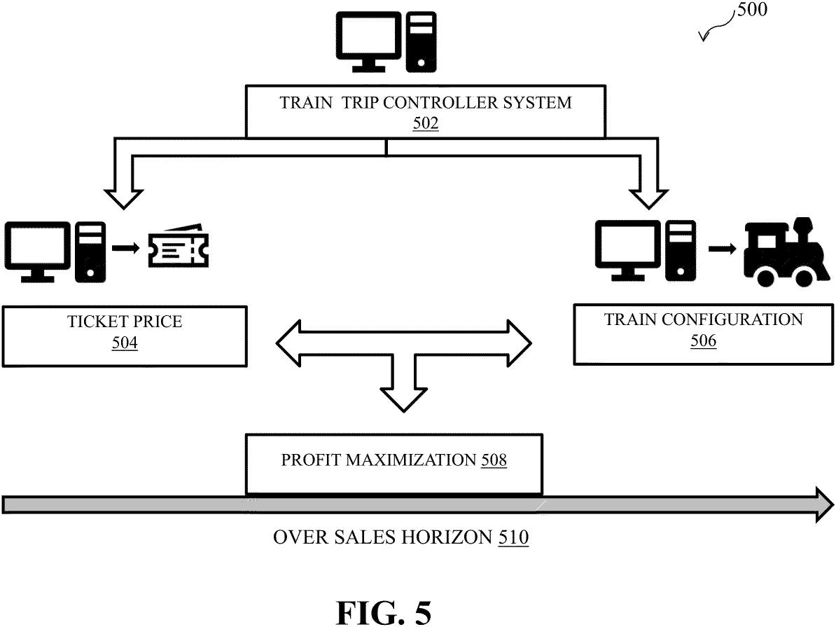

FIG. 5 shows a working example of an end-to-end transportation management system 500, such as one served by the train trip controller system 104 disclosed in various figures described previously, according to some embodiments.

The transportation management system 500 comprises a ticket price system 504, and a train configuration system 506, which are communicatively coupled to a train trip controller system 502 (equivalent to train trip controller system 104). The ticket price system 504 is configured to output a ticket price and the train configuration system 506 is configured to output numbers of passenger cars of each of a reserved and unreserved type. The outputs of both the ticket price system 504 and the train configuration system 506 are based on a control command received from the train trip controller system 502. Further, the outputs of both the ticket price system 504 and the train configuration system 506 are generated with aim of profit maximization 508 for the overall transportation management system 500.

To that end, the train trip controller system 502 is configured to operate in a manner similar to the train trip controller system 104 described in the previous embodiments. For example, the train trip controller system 502 is configured to obtain operational data associated with the train, the operational data comprising at least: itinerary data of a trip of the train, a first constrain data associated with a number of passenger cars in the train, a second constrain data associated with a ratio between reserved passenger cars with reserved seats and unreserved passenger cars with unreserved seats, a cost of adding and removing a passenger car to the train, a sale horizon condition for selling tickets for the reserved seats and the unreserved seats for each leg of the trip, a congestion factor for balancing congestion of standing passengers without seats in the unreserved passenger cars, or a combination thereof.

Further, the train trip controller system 502 is configured to determine an asymptotical upper bound of a stochastic cost function of the operational data, the asymptotical upper bound being computed based on optimization of a first rate of arrival of the passengers for the reserved seats for each leg of the trip and a second rate of arrival of the passengers for the unreserved seats for each leg of the trip. The optimization of the first rate of arrival is performed by optimizing a deterministic cost function of the operational data over a mean of the first rate of arrival.

The optimization of the second rate of arrival is performed by optimizing a deterministic cost function of the operational data over a mean of the second rate of arrival.

Both the optimizations being performed over the sales horizon 510 specified by the sales horizon policy, such as whether the sales horizon policy indicates before sales horizon computations, or after sales horizon computations.

Based on these computations, the train trip controller system 502 is configured to compute the ticket price for outputting in the control command to the ticket price system 504.

Further, the train trip controller system 502 is configured to compute the capacity configuration information for outputting in the control command to the train configuration system 504. Based on this capacity configuration information, any unused passenger cars are removed from the train before commencing on the trip. Further, additional passenger cars may be added based on requirement.

In this manner, the train trip controller system 502 may be able to provide end-to-end transportation management, which may be suitably adapted to any transportation system other than the train trip management system, without deviating from the scope of the present disclosure.

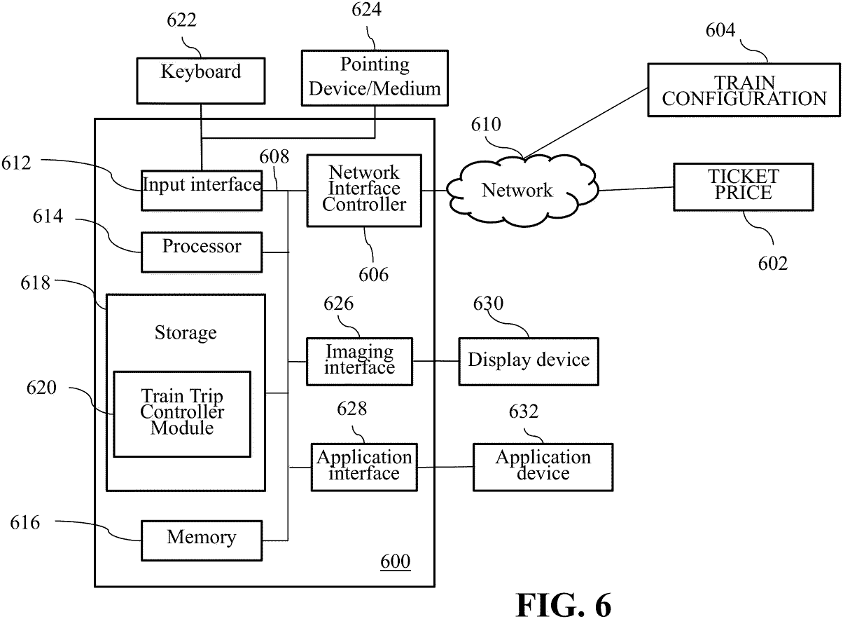

Each of the functionalities of the train trip controller system 502, the ticket price system 504 and the train configuration system 506 may be provided by conventional computing devices including general-purpose computing components. For example, an architecture of one such computing device for the train trip controller system 502 is shown in FIG. 6.

FIG. 6 illustrates an overall block diagram of a system 600 for train trip control by using a ticket price system 602 and a train configuration system 604, according to some embodiments of the present disclosure. FIG. 6 is explained in conjunction with FIG. 1 - FIG. 5. The system 600 may correspond to the system 100. The system 600 may have a number of interfaces connecting the system 600 with the ticket price system 602 and the train configuration system 604. For example, a network interface controller (NIC) 606 is adapted to connect the system 600, through a bus 608, to a network 610. Further, any information associated with an input for the system 600, such as a ticket booking request, may be received via an input interface 612. The input interface 612 may connect the system 600 to a keyboard 622 and/or a pointing device 624. For instance, the pointing device 624 may include a mouse, trackball, touchpad, joystick, pointing stick, stylus, or touchscreen, among others.

The system 600 includes a processor 614 configured to execute stored instructions, as well as a memory 616 that stores instructions that are executable by the processor 614. The processor 614 may be a single core processor, a multi-core processor, a computing cluster, or any number of other configurations. The memory 616 may include random access memory (RAM), read only memory (ROM), flash memory, or any other suitable memory systems. Further, the system 600 includes a storage device 618 adapted to store different modules storing executable instructions for the processor 614. The storage device 618 may be implemented using a hard drive, an optical drive, a thumb drive, an array of drives, or any combinations thereof.

The storage device 618 is configured to store train trip controller module 620. In some embodiments, the processor 614 may be configured to execute the train trip controller module 620 to perform the steps of the flowcharts 300 and 400 described in detailed description of FIG. 3A - FIG. 3B and FIG. 4A - FIG. 4C respectively. For instance, the system 600 may accept a ticket booking request for an itinerary on a train and based on the reception may obtain operational data for the train. The operational data is them used to compute a solution to a deterministic cost function problem over an optimal mean arrival rate of passengers computed over a sales horizon. The solution of the deterministic cost function problem is used to compute a ticket price and a capacity configuration information for sending a control command to each of the ticket price system 602 and the train configuration system 604 respectively.

Additionally, the system 600 may include an imaging interface 626 and application interface 628. The imaging interface 626 connects the system 600 to a display device 630. For instance, the display device 630 includes a computer monitor, television, projector, or mobile device, among other things. The application interface 628 connects the system 600 to an application device 632. For instance, the application device 632 may include the transportation management system or the like. In an example embodiment, the system 600 output the results of the train trip control decisions, via the imaging interface 626 and/or the application interface 628.

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function’s termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

I/We claim:

1. A train trip controller system, comprising:
at least one processor; and
a memory having instructions stored thereon that, when executed by the processor, cause the controller to:
obtain operational data associated with a train, the operational data comprising at least: itinerary data of a trip of the train, a first constraint data associated with a number of passenger cars in the train, a second constraint data associated with a ratio between reserved passenger cars with reserved seats and unreserved passenger cars with unreserved seats, a cost of adding and removing a passenger car to the train, a sale horizon condition for selling tickets for the reserved seats and the unreserved seats for each leg of the trip, a congestion factor for balancing congestion of standing passengers without seats in the unreserved passenger cars, or a combination thereof;
determine an asymptotical upper bound of a stochastic cost function of the operational data, the asymptotical upper bound being computed based on optimization of a first rate of arrival of the passengers for the reserved seats for each leg of the trip and a second rate of arrival of the passengers for the unreserved seats for each leg of the trip,
wherein the optimization of the first rate of arrival and the second rate of arrival is performed jointly by optimizing a deterministic cost function of the operational data over a mean of the first rate of arrival and a mean of the second rate of arrival over the sale horizon;
compute at least a ticket price and a capacity of the train based on the determined upper bound of the cost function; and
submit, over a communication channel including one or a combination of a wired channel or a wireless channel, a control command to control the trip of the train based on the computed ticket price and the capacity of the train.

2. The train trip controller system of claim 1, wherein the itinerary data for the trip of the train comprises data associated with an inverse demand function for all itineraries of the train.

3. The train trip controller system of claim 1, wherein the first constraint data associated with a number of passenger cars in the train comprises at least data of maximum number of passenger cars on the train and minimum number of passenger cars of unreserved type on the train.

4. The train trip controller system of claim 1, wherein the cost of adding and removing a passenger car to the train comprises an operational cost factor associated with either of adding or removing of the passenger car to the train.

5. The train trip controller system of claim 1, wherein the sale horizon condition for selling tickets for the reserved seats and the unreserved seats for each leg of the trip comprises a determination of a sales horizon policy, wherein the sales horizon policy is indicative of at least one of:
optimizing jointly the price of the tickets and the capacity of the train at a start of the sales horizon; or
optimizing jointly the price of the tickets and the capacity of the train at an end of the sales horizon.

6. The train trip controller system of claim 1, wherein the congestion factor for balancing congestion of standing passengers without seats in the unreserved passenger cars comprises determining a penalty function for congestion in unreserved passenger cars.

7. The train trip controller system of claim 1, wherein computing at least the ticket price of the train based on the determined upper bound of the cost function comprises at least one of:
computing a reserved ticket price for reservation of the reserved passenger car based during the sales horizon determined by the sales horizon condition; and
computing an unreserved ticket price for reservation of the unreserved passenger car based during the sales horizon determined by the sales horizon condition.

8. The train trip controller system of claim 1, wherein computing at least the capacity of the train based on the determined upper bound of the cost function comprises at least one of:
computing a reserved capacity for reservation of the reserved passenger car based during the sales horizon determined by the sales horizon condition; and
computing an unreserved capacity price for reservation of the unreserved passenger car based during the sales horizon determined by the sales horizon condition.

9. The train trip controller system of claim 1, wherein computing at least the ticket price and the capacity of the train further comprises:
comparing the capacity with a capacity exhaustion threshold; and
submitting the control command to control the trip of the train based on the comparison, wherein:
based on determining that the capacity of the train is lesser than or equal to the capacity exhaustion threshold, the computed ticket price and the capacity are outputted for the control command submission.

10. The train trip controller system of claim 1, wherein controller is further configured to:
determine a dynamic price factor associated with updating the ticket price after a predetermined time interval; and
update the ticket price when the dynamic price factor is indicative of predetermined time interval having elapsed.

11. The train trip controller system of claim 1, wherein the controller is further configured to:
achieve an optimization objective associated with the deterministic cost function of the operational data over the mean of the first rate of arrival and the mean of the second rate of arrival over the sale horizon.

12. A system for transportation management comprising:
a train trip controller system communicatively coupled to a ticket price system and a train configuration system, the ticket price system configured to output a ticket price, the train configuration system configured to output numbers of passenger cars of each of a reserved and unreserved type, the train trip controller configured to:
obtain operational data associated with the train, the operational data comprising at least: itinerary data of a trip of the train, a first constraint data associated with a number of passenger cars in the train, a second constraint data associated with a ratio between reserved passenger cars with reserved seats and unreserved passenger cars with unreserved seats, a cost of adding and removing a passenger car to the train, a sale horizon condition for selling tickets for the reserved seats and the unreserved seats for each leg of the trip, a congestion factor for balancing congestion of standing passengers without seats in the unreserved passenger cars, or a combination thereof;
determine an asymptotical upper bound of a stochastic cost function of the operational data, the asymptotical upper bound being computed based on optimization of a first rate of arrival of the passengers for the reserved seats for each leg of the trip and a second rate of arrival of the passengers for the unreserved seats for each leg of the trip,
wherein the optimization of the first rate of arrival is performed by optimizing a deterministic cost function of the operational data over a mean of the first rate of arrival, and
the optimization of the second rate of arrival is performed by optimizing a deterministic cost function of the operational data over a mean of the second rate of arrival over the sale horizon;
compute at least a ticket price and a capacity of the train based on the determined upper bound of the cost function; and
submit, over a communication channel including one or a combination of a wired channel or a wireless channel, a control command to control the trip of the train based on the computed ticket price and the capacity of the train, such that the control command comprises a pricing-based command for the ticket price system, and a capacity configuration command for the train configuration system.

13. A method for controlling a train trip, the method comprising:
receiving a ticket booking request;
obtaining operational data associated with a train, the operational data comprising at least: itinerary data of a trip of the train, a first constraint data associated with a number of passenger cars in the train, a second constraint data associated with a ratio between reserved passenger cars with reserved seats and unreserved passenger cars with unreserved seats, a cost of adding and removing a passenger car to the train, a sale horizon condition for selling tickets for the reserved seats and the unreserved seats for each leg of the trip, a congestion factor for balancing congestion of standing passengers without seats in the unreserved passenger cars, or a combination thereof;
determining an asymptotical upper bound of a stochastic cost function of the operational data, the asymptotical upper bound being computed based on optimization of a first rate of arrival of the passengers for the reserved seats for each leg of the trip and a second rate of arrival of the passengers for the unreserved seats for each leg of the trip,
wherein the optimization of the first rate of arrival is performed by optimizing a deterministic cost function of the operational data over a mean of the first rate of arrival over, and
the optimization of the second rate of arrival is performed by optimizing a deterministic cost function of the operational data over a mean of the second rate of arrival over the sale horizon;
computing at least a ticket price and a capacity of the train based on the determined upper bound of the cost function;
submitting, over a communication channel including one or a combination of a wired channel or a wireless channel, a control command to control the trip of the train based on the computed ticket price and the capacity of the train; and
outputting the ticket price for serving of the ticket booking request.
